(19) United States
(12) Patent Application Publication
(10) Pub. No.: US 2024/0411472 A1
(43) Pub. Date: Dec. 12, 2024

(54) MEMORY SYSTEM, INFORMATION PROCESSING DEVICE, INFORMATION PROCESSING SYSTEM, AND METHOD OF RELOCATING DATA

(71) Applicant: Kioxia Corporation, Tokyo (JP)

(72) Inventor: Tetsuya YASUDA, Fujisawa (JP)

(73) Assignee: Kioxia Corporation, Tokyo (JP)

(21) Appl. No.: 18/736,601

(22) Filed: Jun. 7, 2024

(30) Foreign Application Priority Data
Jun. 9, 2023 (JP) 2023-095506

(51) Int. Cl. G06F 3/06

(52) U.S. Cl. CPC G06F 3/0647; G06F 3/0611; G06F 3/064; G06F 3/0679

(57) ABSTRACT

An example memory system includes a non-volatile memory and a controller. The controller is communicatively coupled with a host and configured to control the non-volatile memory. The controller is configured to receive, from the host, first information about mapping of data of a file to a logical address space of the memory system, and relocate, in a physical address space of the non-volatile memory, the data of the file that is fragmented in the physical address space so that the data of the file is continuous in the physical address space based on the received first information, and also on second information in which a correspondence relationship between a logical address indicating a position in the logical address space and a physical address indicating a position in the physical address space is recorded.

### CROSS-REFERENCE TO RELATED APPLICATION

This application is based upon and claims the benefit of priority from Japanese Patent Application No. 2023-095506, filed Jun. 9, 2023, the entire contents of which are incorporated herein by reference.

### FIELD

Embodiments described herein relate generally to a memory system, an information processing device, an information processing system, and a method of relocating data.

### BACKGROUND

In recent years, a solid state drive (SSD) has been widely used as a storage device.

When a host file system maps data of a file to a logical address space of the SSD such as when a file is written to the SSD, the data may be fragmented in some circumstances. When “continuous data” (e.g., data that is all part of a common set), such as data of a file, is fragmented and mapped to the logical address space, the continuous data is likely to be fragmented and mapped also to a physical address space of the SSD.

A file in which the data is fragmented in the physical address space tends to degrade sequential read performance of the SSD as compared with a non-fragmented file.

A general file system typically executes defragmentation by moving the fragmented continuous data in the logical address space to a contiguous area in the logical address space so as to suppress performance degradation as a consequence of the fragmentation. It is expected that the continuous data is also moved to a contiguous area in the physical address space by another defragmentation operation.

The defragmentation is activated by an instruction from an end user. The I/O performance of the SSD degrades during the defragmentation. Therefore, the end user cannot readily instruct the defragmentation operation to be executed. Nevertheless, the SSD cannot automatically recover from the degradation in performance due to the presence of the fragmentation, unless the defragmentation operation is actually executed.

In view of these limitations with conventional systems, at least one exemplary embodiment provides a memory system capable of effectively eliminating fragmentation of data of a file, as well as an information processing device, an information processing system, and a method of relocating data.

### BRIEF DESCRIPTION OF THE DRAWINGS

FIG. 1 is a diagram illustrating an example of a configuration of an information processing system of a first embodiment.

FIG. 2 is a diagram illustrating an example of a configuration of a memory die in a memory system of the first embodiment.

FIG. 3 is a diagram illustrating a configuration of a logical block in the memory system of the first embodiment.

FIG. 4 is a diagram for explaining a first comparative example for data relocation.

FIG. 5 is a diagram for explaining a data relocation by the memory system of the first embodiment.

FIG. 6 is a flowchart illustrating a processing procedure of the data relocation executed by the memory system of the first embodiment.

FIG. 7 is a diagram illustrating a transition example of a file defragmentation state managed by a host in an information processing system of a second embodiment.

FIG. 8 is a diagram illustrating a communication sequence pertaining to file defragmentation between the host and a memory system in the information processing system of the second embodiment.

### DETAILED DESCRIPTION

In general, according to one embodiment, a memory system includes a non-volatile memory and a controller that is communicatively coupled with a host, and configured to control the non-volatile memory. The controller is further configured to receive, from the host, first information about mapping of data of a file to a logical address space of the memory system. And the controller is further configured to relocate, in a physical address space of the non-volatile memory, the data of the file that is fragmented in the physical address space so that the data of the file is continuous in the physical address space based on the received first information, and also on second information in which a correspondence relationship between a logical address indicating a position in the logical address space and a physical address indicating a position in the physical address space is recorded.

Hereinafter, embodiments will be described hereinafter with reference to the accompanying drawings.

### First Embodiment

First, a first embodiment will be described.

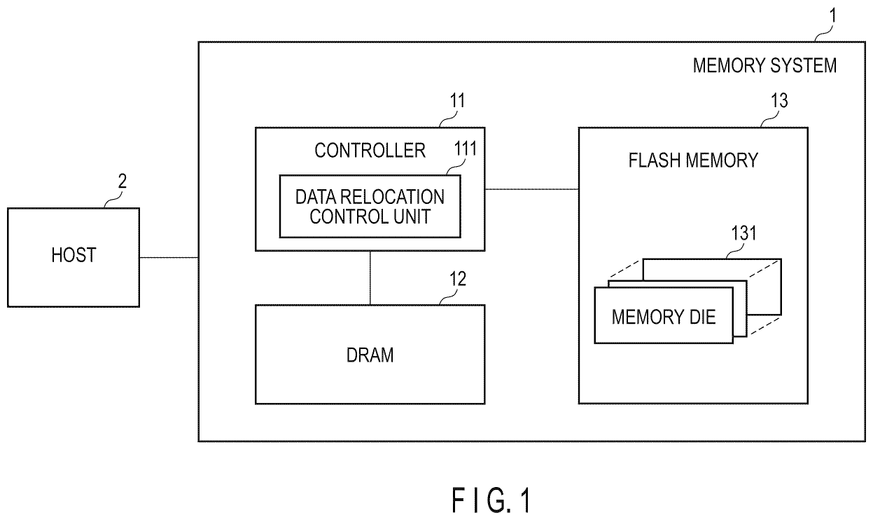

FIG. 1 is a diagram illustrating a configuration example of an information processing system of the first embodiment.

The information processing system includes a memory system 1 and a host 2. There will be described an example in which the memory system 1 is implemented as an SSD. The memory system 1 is configured to be connectable to the host 2. The host 2 is an information processing device (e.g., a type of programmable circuitry that is configured by executing of computer readable code) such as a server or a personal computer. FIG. 1 illustrates a state in which the memory system 1 and the host 2 are communicatively connected to each other.

The memory system 1 includes a controller 11, a dynamic random access memory (DRAM) 12, and a NAND flash memory (hereinafter, referred to as a flash memory) 13. The memory system 1 is connected to the host 2 via an interface conforming to, for example, a PCI Express™ (PCIe™) standard.

The controller 11 is a device that controls the flash memory 13. The controller 11 controls a process of writing data to the flash memory 13 and a process of reading data from the flash memory 13 based on commands from the host 2, while using an area of the DRAM 12 as a work area, for example. The controller 11 communicates with the host 2 by using a protocol conforming to, for example, an NVM Express™ (NVMe™) standard. The controller 11 can be configured as a semiconductor integrated circuit such as a system on a chip (SoC) that is programmably configurable (by execution of computer code) and/or hardwired.

The controller 11 includes a data relocation control unit 111. The term “data relocation control unit” as used herein should be construed as a structural subcomponent of the controller 11 and/or one or more operations that the controller is configured to perform. The data relocation control unit 111 executes data relocation for causing data in a fragmented state in the flash memory 13 to transition to a continuing state. The data relocation control unit 111 will be described in more detail later in this description.

The DRAM 12 is a volatile storage device. Here, an example is shown in which the memory system 1 includes the DRAM 12 as a device for providing a work area to the controller 11. The controller 11 may incorporate a static random access memory (SRAM) to use an area of the SRAM as the work area. That is, a configuration in which the DRAM 12 is not provided is also possible as a configuration example of the memory system 1.

The flash memory 13 is a non-volatile storage device. The flash memory 13 includes a plurality of memory dies 131.

A particular number of memory dies 131 among the plurality of memory dies 131 are used as units of parallel operation of the flash memory 13. The controller 11 selects a physical block from each of the particular number of memory dies 131 used as the units of parallel operation of the flash memory 13, and configures a logical block from the selected particular number of physical blocks. The logical block is an extended management unit (that is part of the flash memory 13) configured so that the controller 11 can efficiently use an area of the flash memory 13. The logical block is also referred to as a super block.

When respective of the plurality of memory dies 131 includes a plurality of planes that can operate in parallel in each memory die 131, the controller 11 selects a physical block from each plane of the particular number of memory dies 131 and establishes a logical block from them.

Here, the logical block configured by the controller 11 will now be described in greater detail.

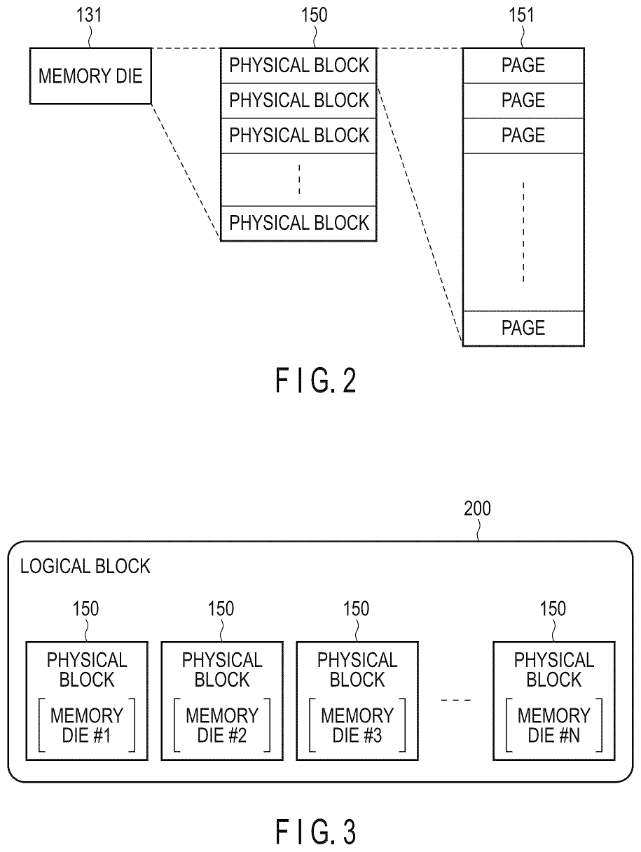

FIG. 2 is a diagram illustrating a configuration example of an exemplary memory die 131.

Each memory die 131 includes a plurality of physical blocks 150. Data erasure in the memory die 131 is executed in units of the blocks 150. Each of the plurality of physical blocks 150 includes a plurality of pages 151. Data written to and read from the memory die 131 are executed in units of the pages 151. In FIG. 2, the planes are not illustrated for the sake of clarity in illustration.

FIG. 3 is a diagram illustrating a configuration example of a logical block 200.

For example, a case will be described where N (where N is a natural number of 2 or more) memory dies 131 are used as a parallel operation unit of the flash memory 13. In this case, the controller 11 selects a physical block 150 from each of the N memory dies 131, and configures a logical block 200 including the selected N physical blocks 150. Since the N physical blocks 150 included in the logical block 200 can operate in parallel, the controller 11 can execute writing of data to the logical block 200 in N-page units, for example.

When respective of the plurality of memory dies 131 includes M (where M is a natural number of 2 or more) planes, N memory dies 131×M planes are used as a parallel operation unit of the flash memory 13. In this case, the controller 11 selects a physical block 150 from each of the M planes for each of the N memory dies 131, and establishes a logical block 200 including the selected N×M physical blocks 150. Since the N×M physical blocks 150 included in the logical block 200 can operate in parallel, the controller 11 can execute writing of data to the logical block 200 in N×M-page units, for example.

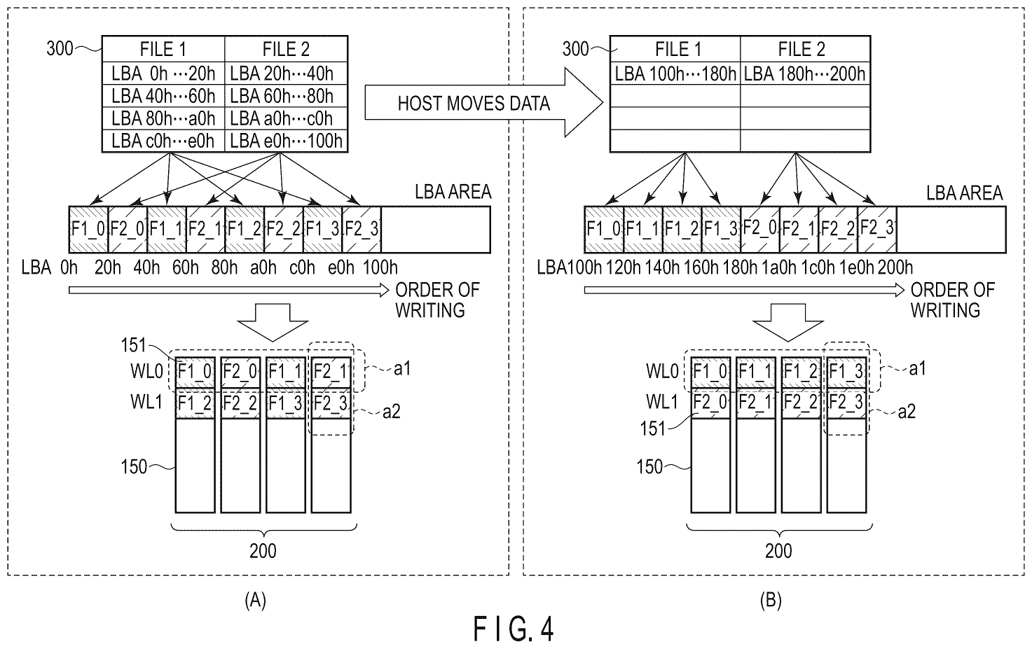

Next, a first comparative example for data relocation will be described with reference to FIG. 4. The first comparative example is an example in which the data relocation for eliminating fragmentation of data of a file is executed by defragmentation by a file system of the host 2.

FIG. 4(A) illustrates an example in which fragmentation of data of a file occurs. Here, writing of a file 1 and writing of a file 2 are executed in parallel, at the same time. A table denoted with reference numeral 300 in FIG. 4(A) indicates a part of mapping information managed by the file system. The mapping information is information about mapping of the data of the file to a logical address space (logical block address (LBA) area) of the memory system 1. The mapping information is an example of first information.

The file system of the host 2, first, maps data for one page of the file 1, and maps data for one page of the file 2, to the logical address space of the memory system 1. Specifically, the file system maps data (F1_0) for first one page of the file 1 to addresses (LBA) 0h-20h of the logical address space and maps data (F2_0) for first one page of the file 2 to addresses 20h-40h thereof.

Subsequently, the file system maps data F1_1 of the file 1 to addresses 40h-60h and maps data F2_1 of the file 2 to addresses 60h-80h.

Similarly, the file system performs mapping of data to the logical address space of the memory system 1 including mapping of data F1_2 of the file 1 to addresses 80h-a0h, mapping of data F2_2 of the file 2 to addresses a0h-c0h, mapping of data F1_3 of the file 1 to addresses c0h-e0h, and mapping of data F2_3 of the file 2 to addresses e0h-100h.

That is, data of both file 1 and file 2 are fragmented and mapped to the logical address space of the memory system 1.

When the data of the file 1 and the data of the file 2 are written to the memory system 1 in mapping order to the logical address space, although the details will be described later, as illustrated in FIG. 4(A), the data of the file 1 and the data of the file 2 are fragmented and located also in the physical address space of the memory system 1, or the flash memory 13. That is, the logical address space of the memory system 1 corresponds to the physical address space which is an available storage area in the flash memory 13 provided in the memory system 1.

Note that a correspondence relationship between the logical address space and the physical address space in the memory system 1 is managed by the controller 11 of the memory system 1 using information referred to as a logical-physical translation table or the like. The logical-physical translation table is an example of second information.

FIG. 4(A) illustrates an example in which a logical block 200 includes four physical blocks 150, for the sake of clarity in illustration. For example, the logical block 200 includes four physical blocks 150 selected from the respective four memory dies 131 among the plurality of memory dies 131. In this case, the four pieces of data of pages 151 connected to a word line (WL) 0 in the respective four physical blocks 150 can be read in parallel (a1). This is also applied to four pieces of data of pages 151 connected to a word line (WL) 1 in the respective four physical blocks 150. On the other hand, a plurality of pieces of data of pages 151 connected to different word lines such as the data of pages 151 connected to the word line 0 and the data of pages 151 connected to the word line 1 must be read sequentially for each word line even when the plurality of pieces of data are stored in the same physical block 150 (a2).

Here, the controller 11 of the memory system 1 manages mapping of the pages 151 to the physical address space so that pages 151 which can be read or written in parallel in the logical block 200 form a group to be continuous. Accordingly, the data of the file 1 and the data of the file 2 illustrated in FIG. 4(A) are in a fragmented state in the physical address space, or the flash memory 13.

To eliminate this fragmentation, when the defragmentation is activated by the file system of the host 2, the host 2 executes reading and writing back of the data of the file 1 and reading and writing back of the data of the file 2. At this time, as illustrated in FIG. 4(B), the file system maps the data of the file 1 to continuous areas of the logical address space when writing back the data of the file 1, and maps the data of the file 2 to continuous areas of the logical address space when writing back the data of the file 2.

That is, in the defragmentation by the file system of the host 2, the data of the file 1 and the data of the file 2 are relocated under the initiative of the host 2. This is expected to eliminate the fragmentation in the logical address space as well as to eliminate the fragmentation in the physical address space. Incidentally, in the memory system 1, to maintain the integrity of the data, the controller 11 may execute internal processing such as writing or reading of data to or from the flash memory 13 regardless of commands from the host 2. Therefore, under the initiative of the host 2, there is no guarantee that the fragmentation in the physical address space can be surely eliminated in association with the elimination of the fragmentation in the logical address space.

Note that a logical block 200 in FIG. 4(B) is different from the logical block 200 in FIG. 4(A). For the sake of clarity in FIG. 4(B) for comparison with FIG. 4(A), an example is illustrated in which the data of a file 1 is relocated to a group of the pages 151 connected to a word line 0, and the data of a file 2 is relocated to a group of the pages 151 connected to a word line 1. However, regardless of positions of the word lines connected to the group of the pages 151 in which the data of the file 1 and the data of the file 2 are stored in the logical block 200 before the relocation, the data may be relocated to the group of the pages 151 connected to any word line in the logical block 200 after the relocation.

Under a scenario where the defragmentation is activated by an instruction from an end user, the I/O performance of the memory system 1 degrades during the defragmentation. Therefore, the end user cannot readily instruct the defragmentation for effective operation. However, as previously discussed, the memory system 1 cannot recover from the performance deterioration due to the fragmentation, unless the defragmentation is executed.

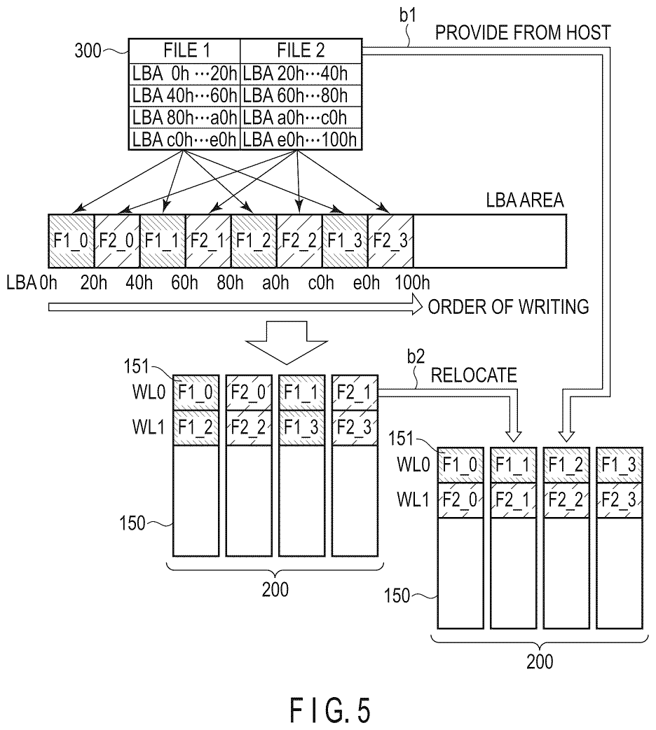

Based on the first comparative example, the data relocation of the memory system 1 of the first embodiment will be next described with reference to FIG. 5.

In the information processing system of the first embodiment, when the fragmentation of the data of the file 1 and the data of the file 2 is to be eliminated, the host 2 provides, to the memory system 1, a part of the mapping information managed by the file system, which includes information about at least the data of the file 1 and the data of the file 2 (b1). Hereinafter, the part of the mapping information provided from the host 2 to the memory system 1 is also referred to as file fragment information. In FIG. 5, the file fragment information includes at least logical addresses of the data of the file 1 and logical addresses of the data of the file 2.

The file fragment information is provided from the host 2 to the memory system 1 when the host 2 issues, to the memory system 1, an extended command defined by the NVMe™ standard, for example. The extended command may be defined as a command in which the host 2 requests the memory system 1 to eliminate the fragmentation of the data.

The file fragment information is received by the controller 11 of the memory system 1. The data relocation control unit 111 of the controller 11 executes relocation of the data of the file 1 and the data of the file 2 based on the file fragment information and the logical-physical translation table managed by the controller 11 (b2). At this time, the data relocation control unit 111 moves the data of the file 1 and the data of the file 2 so that these pieces of data are continuous in the physical address space.

The data relocation control unit 111 executes relocation in the physical address space for eliminating the fragmentation of the continuous data during an idle period during which a processing corresponding to a read command or a write command from the host 2 is not executed. That is, the data relocation by the data relocation control unit 111 is executed as background processing. This can avoid the deterioration of the I/O performance of the memory system 1.

Since the data relocation control unit 111 executes the data relocation in the physical address space as the internal processing of the memory system 1, the controller 11 updates the logical-physical translation table managed thereby, regardless of the management of the host 2. Accordingly, it is unnecessary to update the mapping information managed by the file system of the host 2.

Furthermore, the fragmentation in the physical address space can be surely eliminated by executing the data relocation in the physical address space as the internal processing of the memory system 1 unlike the case of the initiative of the host 2.

When the data relocation in the physical address space by the data relocation control unit 111 is completed, the controller 11 notifies the host 2 that the data relocation has been completed, as a response of the above-described extended command. Accordingly, it is only required that after providing the file fragment information to the memory system 1 with the extended command, the host 2 waits for a response from the memory system 1 without any concern about a progress of the data relocation. That is, it is only required that the host 2 waits for a response indicating the completion of the data relocation while writing the data to the memory system 1 or reading the data from the memory system 1 in the normal way.

Thus, in the information processing system of the first embodiment, the fragmentation of the data of the file can be eliminated efficiently.

Incidentally, the flash memory 13 is a non-volatile storage medium in which data is unable to be overwritten to the page 151 where data is already written. Therefore, the controller 11 executes rewriting of data by writing new data to a page 151 different from a page 151 in which original data is stored and then invalidating the original data. When the number of rewrite cycles of the data is increased, the number of pages 151 in which invalid data is stored is increased. Accordingly, the controller 11 executes “garbage collection” for reusing a plurality of pages 151 in which invalid data is stored.

The garbage collection moves valid data from L (where L is a natural number of 2 or more) logical blocks 200 to K (where K is a natural number of 1 or more and less than L) logical blocks 200 to generate free areas for (L−K) logical blocks 200. The L logical blocks 200 are preferably logical blocks 200 including more of the pages 151 to which invalid data is written.

The data relocation control unit 111 may execute the data relocation required by the host 2 using this garbage collection.

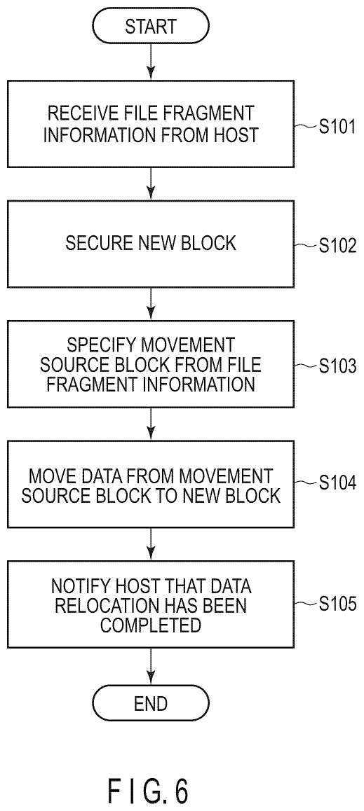

FIG. 6 is a flowchart illustrating a processing procedure of the data relocation executed by the memory system 1 of the first embodiment.

The controller 11 receives the file fragment information from the host 2 (S101). The data relocation control unit 111 of the controller 11 secures a new block for physically and continuously relocating the fragmented data of the file (S102). Note that a block in FIG. 6 is a logical block 200.

The data relocation control unit 111 specifies a movement source block from the file fragment information with reference to the logical-physical translation table (S103). The movement source block is one or more logical blocks 200 in which the fragmented data of the file exists.

The data relocation control unit 111 moves the fragmented data of the file from the movement source block specified in S103 to the new block secured in S102 (S104). When the movement of the data by the data relocation control unit 111 is completed, the controller 11 notifies the host 2 that the data relocation has been completed (S105).

As described above, the information processing system of the first embodiment can eliminate efficiently the fragmentation of the data of the file.

### Second Embodiment

Next, a second embodiment will be described.

In the first embodiment, regarding the data relocation for eliminating the fragmentation of continuous data such as data of a file, the operations performed by the memory system 1 have been mainly described.

In the second embodiment, the operations performed by the host 2 have been mainly described, the operations including control of the timing of issuing an extended command requiring the data relocation to the memory system 1.

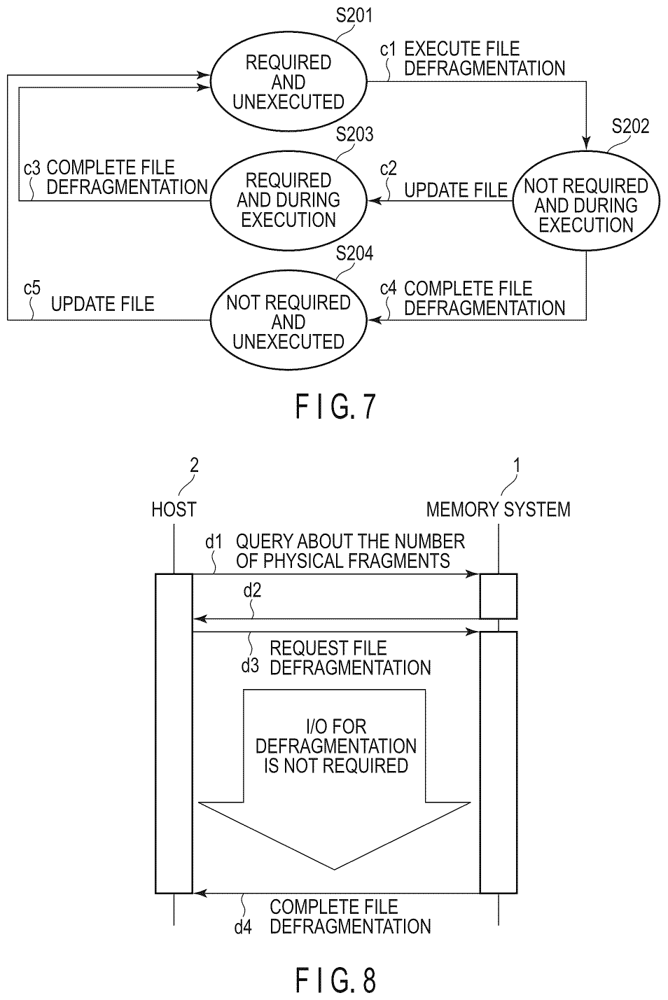

FIG. 7 is a diagram illustrating a transition example of a file defragmentation state managed by the host 2 to determine whether the data relocation is required.

The host 2 manages the file defragmentation state to transition among four states “required and unexecuted” (S201), “not required and during execution” (S202), “required and during execution” (S203), and “not required and unexecuted” (S204). The file defragmentation state is a state indicated in combination of whether the defragmentation of the file is required and whether the defragmentation of the file is being executed or has not been executed yet.

The “required and unexecuted” (S201) refers to a state in which the data relocation is required and the extended command has not been issued to the memory system 1. When the file defragmentation state is “required and unexecuted” (S201), the host 2 issues an extended command requiring the data relocation (file defragmentation) to the memory system 1 (c1). The file fragment information provided to the memory system 1 with the extended command includes the mapping information about files to be subjected to a file update (c2) which occurs at the time of “not required and during execution” (S202) or a file update (c5) which occurs at the time of “not required and unexecuted” (S204), which will be described later.

When the file is updated, the data of the file is likely to be fragmented. Therefore, the host 2 issues an extended command requiring the data relocation to the memory system 1 upon an occurrence of a file update (c1).

When issuing the extended command to the memory system 1, the host 2 causes the file defragmentation state to transition to the “not required and during execution” (S202) (c1). When a file update occurs before the host 2 receives, from the memory system 1, the notice that the data relocation has been completed, the host 2 causes the file defragmentation state to transition to the “required and during execution” (S203) (c2). When a file update occurs at the time of the “required and during execution” (S203), the host 2 maintains the file defragmentation state at the “required and during execution” (S203).

When receiving, from the memory system 1, the notice that the data relocation has been completed after the transition to the “required and during execution” (S203), the host 2 causes the file defragmentation state to transition to the “required and unexecuted” (S201) (c3). Therefore, the host 2 continuously issues a next extended command requiring the data relocation to the memory system 1.

When receiving, from the memory system 1, the notice that the data relocation has been completed without an occurrence of a file update at the time of the “not required and during execution” (S202), the host 2 causes the file defragmentation state to transition to the “not required and unexecuted” (S204) (c4). When the file update occurs at the time of the “not required and unexecuted” (S204), the host 2 causes the file defragmentation state to the “required and unexecuted” (S201) (c5). Therefore, the host 2 issues a next extended command requiring the data relocation to the memory system 1.

While the file defragmentation state is thus managed, the host 2 can issue the extended command requiring the data relocation at appropriate timing. This makes it unnecessary for an end user to issue a defragmentation instruction and can reduce a burden on the end user for considering the timing of issuing the defragmentation instruction.

The host 2 may query the memory system 1 about the number of fragments in the physical address corresponding to the logical address to which data of the target file is mapped, as the pre-processing for issuing an extended command requiring the data relocation to the memory system 1 upon an occurrence of a file update. When the number of fragments notified from the memory system 1 exceeds a threshold, the host 2 may request the data relocation of the memory system 1. In other words, when the number of fragments notified from the memory system 1 is less than or equal to the threshold, the host 2 may suspend the data relocation at that time. The query of the number of fragments is executed by issuing, to the memory system 1, an extended command defined by NVMe™ standard, for example.

FIG. 8 is a diagram illustrating a communication sequence pertaining to the file defragmentation between the host 2 and the memory system 1 in an information processing system of the second embodiment.

When the file is updated, the host 2 queries the memory system 1 about the number of fragments in the physical address corresponding to the logical address to which the target file is mapped (d1). At this time, the host 2 notifies the memory system 1 of the logical address of the target file. The memory system 1 obtains the number of fragments of the data in the physical address of the target file from the file fragment information provided from the host 2 with the reference to the logical-physical translation table, and transmits the obtained number of fragments to the host 2 (d2).

When the number of fragments obtained from the memory system 1 exceeds the threshold, the host 2 issues, to the memory system 1, an extended command requiring the data relocation (file defragmentation) for eliminating the fragmentation of the data of the target file (d3). After issuing the extended command, it is only required that the host 2 writes the data to the memory system 1 or read the data from the memory system 1 in the normal way, regardless the required defragmentation.

The memory system 1 executes the required data relocation as the background processing during an idle period during which the processing corresponding to a write command or a read command from the host 2 is not executed. When the data relocation is completed, the memory system 1 notifies the host 2 that the data relocation has been completed, as a response of the received extended command (d4).

As described above, according to the information processing system of the second embodiment, the fragmentation of the data of the file can be eliminated efficiently through cooperation between the host 2 and the memory system 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory; and
a controller that is communicatively coupled with a host, and configured to control the non-volatile memory,
wherein the controller is further configured to
receive, from the host, first information about mapping of data of a file to a logical address space of the memory system; and
relocate, in a physical address space of the non-volatile memory, the data of the file that is fragmented in the physical address space so that the data of the file is continuous in the physical address space based on the received first information, and also on second information in which a correspondence relationship between a logical address indicating a position in the logical address space and a physical address indicating a position in the physical address space is recorded.

2. The memory system of claim 1, wherein
the controller is further configured to relocate the fragmented data during an idle period during which data is not read from the non-volatile memory in accordance with a read command from the host or data is not written to the non-volatile memory in accordance with a write command from the host.

3. The memory system of claim 1, wherein
the controller is further configured to:
communicate with the host according to a protocol that conforms to a specific standard;
receive, from the host, the first information in accordance with a first command defined as an extended command by the specific standard; and
detect a number of fragments of the data of the file in the physical address space based on the first information and the second information in accordance with the first command, and transmit to the host information of the number of fragments.

4. The memory system of claim 3, wherein
the controller is further configured to relocate the fragmented data after receipt, from the host, of a second command that is different from the first command and defined as the extended command by the specific standard after transmission to the host of the information of the number of fragments.

5. The memory system of claim 1, wherein
the non-volatile memory has a plurality of blocks, each of the plurality of blocks is an erasure unit of data; and
the controller is further configured to relocate the fragmented data by using garbage collection including a move of valid data from L blocks to K blocks, where L is a natural number of 2 or more, where K is a natural number of 1 or more and less than L, so as to generate free areas for (L−K) blocks.

6. The memory system of claim 1, wherein
the controller is further configured to relocate the fragmented data of the file in the physical address space so that the data of the file is continuous and accessible via a first word line.

7. The memory system of claim 6, wherein
the controller is further configured to relocate other data of another file that is also fragmented in the physical address space so that the data of the another file is continuous and accessible via a second word line, the second word line being different than the first word line.

8. An information processing system, comprising:
circuitry configured to
update data of a file stored in a non-volatile memory of a memory system;
query the memory system about a number of fragments of the data of the file in a physical address space of the non-volatile memory after the data of the file is updated; and
when the number of fragments obtained from the memory system exceeds a threshold,
provide, to the memory system, first information about mapping of the data of the file to a logical address space of the memory system; and
instruct the memory system to relocate, in the physical address space, the data of the file that is fragmented in the physical address space so that the data of the file is continuous in the physical address space.

9. The information processing system of claim 8, further comprising:
the non-volatile memory provided in the memory system; and
a controller that is communicatively coupled to the circuitry, and configured to control the non-volatile memory,
wherein the controller is further configured to
receive, from the circuitry, first information about mapping of data of the file to the logical address space of the memory system, and
relocate, in the physical address space, the data of the file that is fragmented in the physical address space so that the data of the file is continuous in the physical address space based on the received first information, and also on second information in which a correspondence relationship between a logical address indicating a position in the logical address space and a physical address indicating a position in the physical address space is recorded.

10. The information processing system of claim 9, wherein
the controller is further configured to relocate the fragmented data during an idle period during which data is not read from the non-volatile memory in accordance with a read command from the circuitry or data is not written to the non-volatile memory in accordance with a write command from the circuitry.

11. The information processing system of claim 9, wherein the controller is further configured to:
communicate with the circuitry according to a protocol that conforms to a specific standard;
receive, from the circuitry, the first information in accordance with a first command defined as an extended command by the specific standard; and
detect the number of fragments of the data of the file in the physical address space based on the first information and the second information in accordance with the first command, and transmit to the circuitry the information of the number of fragments.

12. The information processing system of claim 11, wherein
the controller is further configured to relocate the fragmented data after receipt, from the circuitry, of a second command that is different from the first command and defined as the extended command by the specific standard after transmission to the circuitry of the information of the number of fragments.

13. The information processing system of claim 9, wherein
the non-volatile memory has a plurality of blocks, each of the plurality of blocks is an erasure unit of data; and
the controller is further configured to relocate the fragmented data by using garbage collection including a move of valid data from L blocks to K blocks, where L is a natural number of 2 or more, where K is a natural number of 1 or more and less than L, so as to generate free areas for (L−K) blocks.

14. The information processing system of claim 8, wherein
the circuitry is further configured to instruct the memory system to relocate the fragmented data of the file in the physical address space so that the data of the file is continuous and accessible via a first word line.

15. The information processing system of claim 14, wherein
the circuitry is further configured to instruct the memory system to relocate other data of another file that is also fragmented in the physical address space so that the data of the another file is continuous and accessible via a second word line, the second word line being different than the first word line.

16. A method of relocating data in a memory system having a non-volatile memory, comprising:
receiving first information about mapping of data of a file to a logical address space of the memory system; and
relocating the data of the file in a physical address space of the non-volatile memory so that the data of the file is continuous in the physical address space based on the received first information, and also on second information in which a correspondence relationship between a logical address indicating a position in the logical address space and a physical address indicating a position in the physical address space is recorded.

17. The method of claim 16, wherein
the relocating includes relocating the fragmented data during an idle period during which data is not read from the non-volatile memory in accordance with a read command from the host or data is not written to the non-volatile memory in accordance with a write command from the host.

18. The method of claim 16, further comprising:
communicating from a controller with the host according to a protocol that conforms to a specific standard;
receiving, from the host, the first information in accordance with a first command defined as an extended command by the specific standard; and
detecting a number of fragments of the data of the file in the physical address space based on the first information and the second information in accordance with the first command, and transmit to the host information of the number of fragments.

19. The method of claim 18, wherein
the relocating includes relocating the fragmented data after receipt, from the host, of a second command that is different from the first command and defined as the extended command by the specific standard after transmission to the host of the information of the number of fragments.

20. The method of claim 16, wherein
the non-volatile memory has a plurality of blocks each of the plurality of blocks is an erasure unit of data, and
the method further comprising relocating the fragmented data by using garbage collection including a move of valid data from L blocks to K blocks, where L is a natural number of 2 or more, where K is a natural number of 1 or more and less than L, so as to generate free areas for (L−K) blocks.
